(19) United States
(12) Patent Application Publication
(10) Pub. No.: US 2017/0171642 A1
(43) Pub. Date: Jun. 15, 2017

(54) ELECTRONIC DEVICE, VIDEO RECOMMENDING METHOD

(71) Applicants: LE HOLDINGS (BEIJING) CO., LTD., BEIJING (CN); LE SHI INTERNET INFORMATION TECHNOLOGY CORP. BEIJING, BEIJING (CN)

(72) Inventor: Qingqing HAN, Beijing (CN)

(21) Appl. No.: 15/249,705

(22) Filed: Aug. 29, 2016

Related U.S. Application Data
(63) Continuation of application No. PCT/CN2016/089361, filed on Jul. 8, 2016.

(30) Foreign Application Priority Data
Dec. 9, 2015 (CN) 201510907403.9

(51) Int. Cl. H04N 21/81; H04N 21/435; H04N 21/482; H04N 21/472; H04N 21/466

(52) U.S. Cl. CPC H04N 21/8133; H04N 21/47202; H04N 21/4668; H04N 21/4826; H04N 21/4828; H04N 21/435

(57) ABSTRACT

Embodiments of the present disclosure disclose an electronic device and a video recommending method, which are applied to a video playing platform. Specifically, when a user makes an on-demand on playing a target video of the video playing platform, a default attribute of the target video is obtained, and then a related attribute related to the default attribute is searched for in a preset relationship circle; subsequently, related videos having the related attribute are searched for in a video library, and the related videos searched out are recommended to the user.

### CROSS-REFERENCE TO RELATED APPLICATIONS

The present disclosure continuation of International Application No. PCT/CN2016/089361, filed on Jul. 8, 2016, which is based upon and claims priority to Chinese Patent Application No. 201510907403.9, filed on Dec. 9, 2015, and the entire contents of all of which are incorporated herein by reference.

### FIELD OF TECHNOLOGY

The present disclosure generally relates to the technical field of video playing, and in particular, to an electronic device, video-recommending method.

### BACKGROUND

With the development of computers and Internet technologies, networks provide not only various kinds of assistance for people's work, but also various rich kinds of rich and colorful information for people's daily lives, making people's daily lives more colorful.

Specifically, a video playing platform is a network platform offering people various kinds of rich and colorful audio-visual entertainment data. A video-on-demand service is offered, so that people can enjoy their own interesting audio-visual data at anytime and anywhere. When people are enjoying audio-visual data, they are often interested not only in the current audio-visual data demanded, but also in other data related to the current audio-visual data most probably. However, audio-visual data saved by the video playing platform exists independently without correlation with each other. As a result, users can't obtain clues of other data while playing the current audio-visual data, and may only find out other interested audio-visual data through specific searches, thereby resulting in poor user experience.

### SUMMARY

For this reason, the present disclosure discloses a video recommending method applied to a video playing platform to solve the problem of poor user experience due to that users cannot obtain clues to other interested audio-visual data from the current audio-visual data.

An embodiment of the present disclosure discloses a video recommending method, including:
when a user makes an on-demand on playing a target video, obtaining a default attribute of the target video, wherein the default attribute includes a target person in the target video;
searching for a related attribute related to the default attribute in a preset relationship circle;
searching for related videos having the related attribute in a video library;
recommending the related videos to the user.

Correspondingly, an embodiment of the present disclosure further discloses an electronic device, including: at least one processor; and a memory communicably being connected with the at least one processor for storing instructions executable by the at least one processor, wherein execution of the instructions by the at least one processor causes the at least one processor to:
when a user makes an on-demand on playing a target video, obtain a default attribute of the target video;
search for a related attribute related to the default attribute in a preset relationship circle, wherein the default attribute includes a target person in the target video;
search for related videos having the related attribute in a video library;
recommend the related videos to the user.

An embodiment of the present disclosure discloses a computer program, including computer-readable codes, wherein when the computer-readable codes are run on a server, the server is led to execute the video recommending method above.

An embodiment of the present disclosure discloses a computer readable medium storing the computer program above.

### BRIEF DESCRIPTION OF THE DRAWINGS

In order to more clearly illustrate the technical solutions in the embodiments of the present disclosure or the prior art, accompanying drawings needing to be used in the descriptions of the embodiments or the prior art will be introduced below briefly. Apparently, the accompanying drawings in the descriptions below are some embodiments of the present disclosure, and for a person skilled in the art, other drawings may also be obtained according to the accompanying drawings without creative work.

FIG. 1 is a step flow diagram of a video recommending method embodiment provided by the present disclosure.

FIG. 2 is a structural block diagram of a video recommending system embodiment provided by the present disclosure.

FIG. 3 is a structural block diagram of another video recommending system embodiment provided by the present disclosure.

FIG. 4 schematically shows a block diagram of an electronic device for executing a method according to the present disclosure.

FIG. 5 schematically shows a storage unit for holding or carrying program codes for executing a method according to the present disclosure.

### DETAILED DESCRIPTION

In order to make the objectives, technical solutions and advantages of the embodiments of the present disclosure more clear, the technical solutions in the embodiments of the present disclosure will be described below clearly and completely in conjunction with the accompanying drawings in the embodiments of the present disclosure. Apparently, the described embodiments are part of embodiments of the present disclosure rather than all. On the basis of the embodiments in the present disclosure, all the other embodiments obtained by a person skilled in the art without creative work should fall into the scope of protection of the present disclosure.

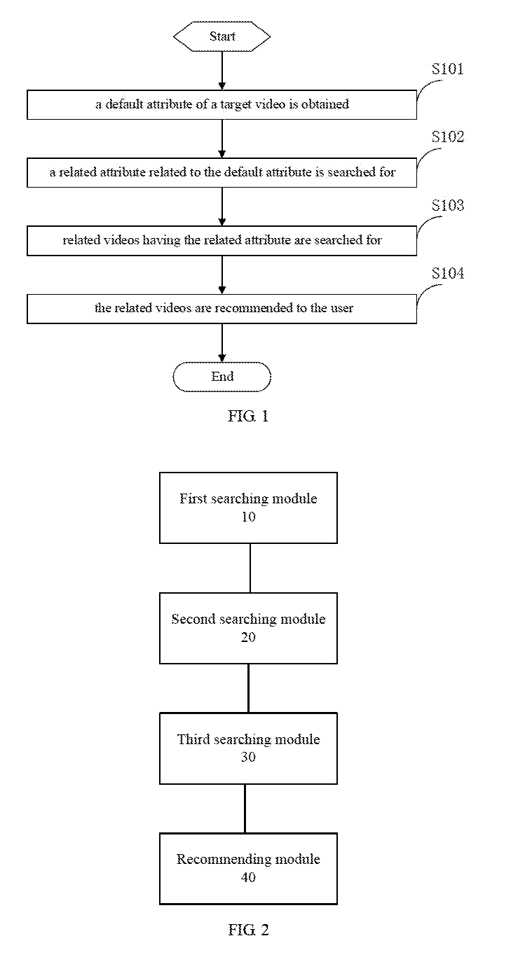

FIG. 1 is the step flow diagram of the video recommending method embodiment provided by the present disclosure.

As shown in FIG. 1, the video recommending method provided by the present disclosure is applied to a server offering users a video-on-demand or video downloading service, and may specifically include the steps as follows.

In step S101, a default attribute of a target video is obtained.

When a user makes an on-demand on playing the target video or downloads the target video through the video playing platform, it indicates that the user may possibly be interested in other related videos related to the target video. Based on this, a default attribute is obtained from the target video that is demanded to play or downloaded by the user. Generally, a target person in the target video are selected as the default attribute.

Concerning the attribute of attention of general users to movies or television dramas, they will pay more attention to movie and television stars such as starring therein and so on. Therefore, the movie and television stars playing roles in the video are selected as the a target person. Certainly, due to that concerns of users differ in thousands ways, the movie and television stars may be either leading roles or supporting role. For the movie and television works of famous directors or producers, the directors or the producers can also be selected as the default attribute.

In step S102, a related attribute related to the default attribute is searched for.

The related attribute related to the default attribute is searched for in a preset relationship circle. For example, one movie and television star is selected as the default attribute, and then other movie and television stars in a certain bond relationship with the movie and television star can be found out. The bond relationship may be father and son, teacher and student, friends, husband and wife, lovers, schoolmates, or other relationships.

Searching in this step is based on the preset relationship circle. A method for predefining the relationship circle includes the steps as follows.

In step 1, detailed information of each target person is collected.

Specifically, the movie and television stars who are now well-known to or attract attention of audiences at random levels are found out comprehensively, and the detailed information of every movie and television star is collected.

In Step 2, alternative persons tied to with each target person are searched for in the detailed information.

The detailed information of every movie and television star includes that alternative persons in the above bond relationship with this star; therefore, based on the collected detailed information of every movie and television star, other movie and television stars in relationships with this star can be found out. Such a related factor is referred to as a static related factor herein.

In Step 3, the relationship circle is established centered on each target person.

Specifically, a relationship network consisting of related alternative persons is established centered on the target person. Because every movie and television star may be correspondingly related to other movie and television stars by the bond relationships, the relationship circle will be formed into a three-dimension network structure.

In step S103, related videos having the related attribute are searched for in a video library.

Specifically, other videos in which the other movie and television stars related play leading or supporting roles are searched for in the video library of the video playing platform. Certainly, videos directed or produced by the related directors or producers may also be included. For the sake of convenience in descriptions, the videos searched out are referred to as the related videos.

In step S104, the related videos are recommended to the user.

Specifically, the related videos searched out are recommended to the user when the user watches or downloads the video. Specific to the recommending mode, it may include displaying names of the related videos in the form of a list at a preset position of a video playing or downloading interface; for example, the names are displayed at the bottom of a half-screen playing page; alternatively, the names of the recommended other videos may be displayed in a full-screen mode after the video ends. Specifically, for recommending, all the videos may he recommended, or part of the videos may be recommended based on various circumstances (e.g., by class or year), which is not limited herein in this present disclosure.

It can be seen from the above technical solution that this embodiment is the video recommending method embodiment. The video recommending method is applied to the video playing platform. Specifically, when a user makes an on-demand of playing a target video of the video playing platform, the default attribute of the target video is obtained, and then the related attribute related to the default attribute is searched for in the preset relationship circle; subsequently, the related videos having the related attribute are searched for in the video library, and the related videos searched out are recommended to the user. Therefore, the user can obtain clues to other interested audio-visual data without searching specifically; the use experience of the user thus can be greatly enhanced.

In addition, the related factor in this embodiment may also include a dynamic related factor or an event related factor, apart from the above-mentioned static related factor. Specifically, when two movie and television stars get involved in a certain event, it can be regarded that there is the event related factor between the two stars. For example, the specific event of Xiaoming Huang and angelababy getting married may correlate Xiaoming Huang and angelababy.

It needs to be noted that concerning the method embodiment, for the sake of simple description, it is entirely expressed as a combination of a series of actions; however, a person skilled in the art should know that the embodiments of the present disclosure are not limited by the described order of actions, because some steps may be carried out in other orders or simultaneously according to the embodiment of the present disclosure. For another, a person skilled in the art should also blow that the embodiment described in the description is the alternative embodiment, and the actions involved therein are not necessary for the embodiments of the present disclosure.

FIG. 2 is the structural block diagram of the video recommending system embodiment provided by the present disclosure.

As shown in FIG. 2, the video recommending system provided by the present disclosure is applied to a server offering users a video-on-demand or video downloading service, and may specifically include a first searching module 10, a second searching module 20, a third searching module 30, and a recommending module 40.

The first searching module 10 is used for obtaining a default attribute of a video.

When a user makes an on-demand of playing the target video or downloads the target video through the video playing platform, it indicates that the user may possibly be interested in other related videos related to the target video. Based on this, the first searching module 10 obtains timely the default attribute from the target video that is demanded to play or downloaded by the user.

Concerning the attribute of attention of general users to movies or television dramas, they will pay more attention to movie and television stars such as starring therein and so on. Therefore, the movie and television stars playing roles in the video are selected as the target person. Certainly, due to that concerns of users differ in thousands ways, the movie and television stars may be either leading roles or supporting role. For the movie and television works of famous directors or producers, the directors or the producers can also be selected as the default attribute.

The second searching module 20 is used for searching for a related attribute related to the default attribute in a preset relationship circle. For example, one movie and television star is selected as the default attribute, and then other movie and television stars in a certain bond relationship with the movie and television star can be found out. The bond relationship may be father and son, teacher and student, friends, husband and wife, lovers, schoolmates, or other relationships.

The third searching module 30 is used for searching for related videos having the related attribute in a video library.

Specifically, the related videos in which the other movie and television stars related play leading or supporting roles are searched for in the video library of the video playing platform. Certainly, videos directed or produced by the related directors or producers may also be included.

The recommending module 40 is used for recommending the related videos to the user.

Specifically, the related videos searched out are recommended to the user when the user watches or downloads the video. Specific to the recommending mode, it may include displaying names of the related videos in the form of a list at a preset position of a video playing or downloading interface; for example, the names are displayed at the bottom of a half-screen playing page; alternatively, the names of the recommended videos may be displayed in a full-screen mode after the video ends.

It can be seen from the above technical solution that this embodiment is the video recommending system embodiment. The video recommending system is applied to the video playing platform. Specifically, when a user makes an on-demand of playing, a target video of the video playing platform, the default attribute of the target video is obtained, and then the related attribute related to the default attribute is searched for in the preset relationship circle; subsequently, the related videos having the related attribute are searched for in the video library, and the related videos searched out are recommended to the user. Therefore, the user can obtain clues to other interested audio-visual data without searching specifically; the use experience of the user thus can be greatly enhanced.

In addition, the related factor in this embodiment may also include a dynamic related factor or an event related factor, which is not redundantly described herein in consideration of the detailed description made in the previous embodiment.

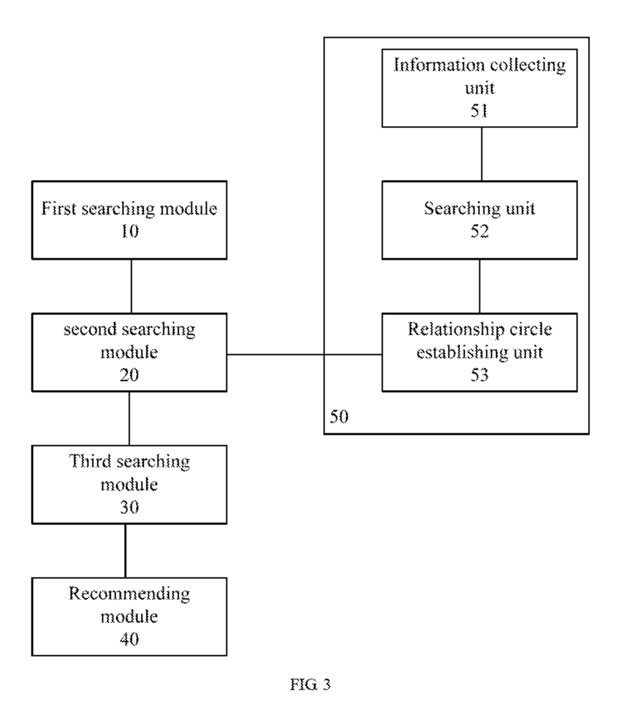

FIG. 3 is the structural block diagram of another video recommending system embodiment provided by the present disclosure.

As shown in FIG. 3, the video recommending system provided by the present disclosure is added with a relationship circle predefining module 50 on the basis of the previous embodiment. The relationship circle predefining module 50 is used for predefining the relationship ring on which searching by the second searching module 20 is based, and specifically includes an information collecting unit 51, a searching unit 52, and a relationship circle establishing unit 53.

The information collecting unit 51 is used for collecting the detailed information of each target person from multiple angles.

Specifically, the movie and television stars who are now well-known to or attract attention of audiences at random levels are found out comprehensively, and the detailed information of every movie and television star is collected.

The searching unit 52 is used for searching for alternative persons tied to with each target person in the detailed information.

The detailed information of every movie and television star includes that alternative persons in the above bond relationship with this star; therefore, based on the detailed information of every movie and television star collected by the information collecting unit 51, the searching unit 52 may find out other movie and television stars in relationships with this star.

The relationship circle establishing unit 53 is used for establishing the relationship circle centered on each target person.

Specifically, a relationship network consisting of related alternative persons is established centered on the target person. Because every movie and television star may be correspondingly related to other movie and television stars by the bond relationships, the relationship circle will be formed into a three-dimension network structure.

In regard to the device embodiments, they are just simply described as being substantially similar to the method embodiment, and the correlations therebetween just refer to part of descriptions of the method embodiment.

Each embodiment in the description is described in a progressive manner. Descriptions emphasize on the differences of each embodiment from other embodiments, and same or similar parts of various embodiments just refer to each other.

The device embodiment described above is merely schematic, wherein the units illustrated as separate components may be physically separated or not; components displayed as units may be physical units or not, which can be located at the same place or distributed to a plurality of network units. Part or all of the modules may be selected according to actual requirements to achieve the purposes of the solutions of the embodiments. A person skilled in the art can understand and implement the solutions without creative work.

According to the descriptions of the above embodiments, a person skilled in the art could clearly learn that the embodiments may be realized by means of software and a necessary general hardware platform, and of course, may also be realized by hardware. Based on such an understanding, the above technical solutions substantially or the part making contribution to the prior art may be embodied in the form of a software product, and the computer software product may be stored in a computer-readable storage medium, such as an ROM/RAM, a magnetic disk, an optical disk, or the like, which includes a plurality of commands for enabling computer equipment (which may be a personal computer, a server, network equipment, or the like) to execute each embodiment or methods mentioned in some parts of the embodiments.

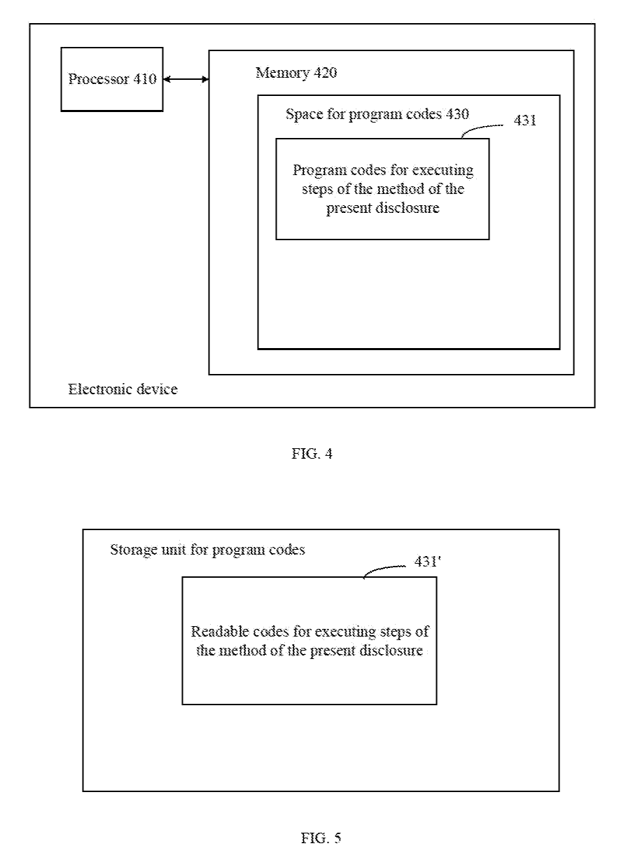

For example, FIG. 4 illustrates a block diagram of an electronic device for executing the method according the disclosure. The electronic device may be the server above. Traditionally, the electronic device includes a processor 410 and a computer program product or a computer readable medium in form of a memory 420. The memory 420 could be electronic memories such as flash memory, EEPROM (Electrically Erasable Programmable Read-Only Memory), EPROM, hard disk or ROM. The memory 420 has a memory space 430 for executing program codes 431 of any steps in the above methods. For example, the memory space 430 for program codes may include respective program codes 431 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 5. The memory cells may be provided with memory sections, memory spaces, etc., similar to the memory 420 of the electronic device as shown in FIG. 4. The program codes may be compressed for example in an appropriate form. Usually, the memory cell includes computer readable codes 431′ which can be read for example by processors 410. When these codes are operated on the electronic device, the electronic device may execute respective steps in the method as described above.

Finally, it should be noted that the above embodiments are merely used for illustrating, rather than limiting, the technical solutions of the present disclosure. Although the present disclosure is described in detail with reference to the aforementioned embodiments, it should be understood by a person skilled in the art that modifications may still be made to the technical solutions described in the aforementioned embodiments, or equivalent alternatives may be applied to part of the technical features therein; these modifications or alternatives do not cause the nature of the corresponding technical solutions to depart from the spirit and the scope of the technical solutions in the embodiments of the present disclosure.

What is claimed is:

1. A video recommending method, comprising:
at a server;
when a user makes an on-demand on a target video, obtaining a default attribute of the target video, wherein the default attribute includes a target person in the target video;
searching for a related attribute related to the default attribute in a preset relationship circle;
searching for related videos having the related attribute in a video library;
recommending the related videos to the user.

2. The video recommending method according to claim 1, wherein the target person comprise a movie and television star in the target video.

3. The video recommending method according to claim 1, wherein a method for presetting the relationship circle comprises:
collecting detailed information of the target person;
searching for alternative persons tied to the target person in the detailed information;
establishing the relationship circle including the alternative persons centered on each of the target person.

4. The video recommending method according to claim 1, wherein the recommending the related videos to the user comprises:
displaying names of the related videos in a list form at a preset position of a video playing interface, or displaying the names in a full-screen mode after the video ends.

5. The video recommending method according to claim 1, wherein the related attribute further comprises:
an event related attribute involved in a certain event together with the default attribute.

6. An electronic device, comprising:
at least one processor; and
a memory communicably connected with the at least one processor for storing instructions executable by the at least one processor, wherein execution of the instructions by the at least one processor causes the at least one processor to:
when a user makes an on-demand on a target video, obtain a default attribute of the target video, wherein the default attribute includes a target person in the target video;
search for a related attribute related to the default attribute in a preset relationship circle;
search for related videos having the related attribute in a video library;
recommend the related videos to the user.

7. The electronic device according to claim 6, wherein the target person comprises a movie and television star in the target video.

8. The electronic device according to claim 6, wherein the execution of the instructions by the at least one processor causes the at least one processor to predefine the relationship circle to obtain the preset relationship circle, comprises:
collect detailed information of the target person;
search alternative persons tied to the target person in the detailed information;
establish the relationship circle including the alternative persons centered on each of the target person.

9. The electronic device according to claim 6, wherein the step to recommend the related videos to the user comprises:
display names of the related videos in a list form at a preset position of a video playing interface, or display the names in a full-screen mode after the video ends.

10. The electronic device according to claim 6, wherein the related attribute further comprises:
an event related attribute involved in a certain event together with the default attribute.

11. A non-transitory computer-readable medium, storing executable instructions that, when executed by an electronic device, cause the electronic device to:
when a user makes an on-demand on a target video, obtain a default attribute of the target video, wherein the default attribute includes a target person in the target video;
search for a related attribute related to the default attribute in a preset relationship circle;
search for related videos having the related attribute in a video library;
recommend the related videos to the user.

12. The non-transitory computer-readable medium according to claim 11, wherein the target person comprise a movie and television star in the target video.

13. The non-transitory computer-readable medium according to claim 11, wherein when executed by an electronic device, cause the electronic device to predefine the relationship circle to obtain the preset relationship circle, comprises:
collect detailed information of the target person;
search for alternative persons tied to the target person in the detailed information;
establish the relationship circle including the alternative persons centered on each of the target person.

14. The non-transitory computer-readable medium according to claim 11, wherein the step to recommend the related videos to the user comprises:
display names of the related videos in a list form at a preset position of a video playing interface, or display the names in a full-screen mode after the video ends.

15. The non-transitory computer-readable medium according to claim 11, wherein the related attribute further comprises:
an event related attribute involved in a certain event together with the default attribute.
